(19) United States
(12) Patent Application Publication
(10) Pub. No.: US 2012/0008278 A1
(43) Pub. Date: Jan. 12, 2012

(54) BRACKET FOR FIXING ADDITIONAL CARD OF COMPUTER

(75) Inventor: Yi-Song Huang, Taipei (TW)

(73) Assignee: NEXCOM INTERNATIONAL CO. LTD., Chung-Ho City (TW)

(21) Appl. No.: 12/830,592

(22) Filed: Jul. 6, 2010

(51) Int. Cl. G06F 1/16

(52) U.S. Cl. 361/679.58

(57) ABSTRACT

The present invention relates to a bracket for fixing an additional card of a computer. The bracket is installed on a card slot so as to fasten the additional card inserted into the card slot and comprises: a cover, a first fixing portion, two second fixing portions, an elastic portion, and an auxiliary portion, wherein the first fixing portion is able to retain the additional card and avoid the additional card falling off, the two ends of the two second fixing portions have two third fixing portions respectively, the bracket can be attached to the card slot by using the two second fixing portions and the third portion, furthermore, the elastic portion and the first fixing portion are to fix the two sides of the additional card; besides, through the elasticity of the auxiliary portion, the bracket can be installed on the card slot.

### BACKGROUND OF THE INVENTION

1. Technical Field

The present invention relates to a bracket, and more particularly, to a bracket capable of fixing a removable additional card of a computer.

2. Description of Related Art

A commercial computer basically has a motherboard, a CPU, a RAM, and a graphic card. The computer is adapted to assist people to deal with many things, such as word-processing, program-compiling, etc. When it is desired to expend functions of the computer, an additional card with specific function is able to be installed on a card slot of the motherboard, for example, to install a compact flash (CF) card on the card slot.

With the advent of the digital times, people carry the computer all the time, however, when being carried, the computer is bound by suffer shock, collision or falling to ground, so as to cause loosing of the additional card installed in the card slot. Accordingly, inventors work hardly for improving the condition of the loosing of the additional card. Please referring to FIGS. 1A and 1B, which illustrate schematic views of a fixing device for the additional card disposed on the card slot, the fixing device for the additional card 20′ is disclosed in an R.O.C patent whose patent number is M311221, wherein the fixing device for the additional card 20′ includes: a horizontal portion 22′ and a vertical portion 21′; two ear portions 221′ are formed on two ends of the horizontal portion 22′, and each ear portion 221′ has two through hole 222′. As shown in FIGS. 1A and 1B, after an additional card 11′ is inserted into a card slot 12′ disposed on a circuit board 10′, the fixing device for the additional card 20′ can be fastened on the card slot 12′ through two screw-and-nut modules 30′ and two copper bars 23′, so that, as show in FIG. 1B, the horizontal portion 22′ covers the surface of the additional card 11′ and the vertical portion 21′ covers the side face of the additional card 11′, so as to complete fixing the additional card 11′.

The fixing device for the additional card 20′ described above is able to fix the additional card 11′, then the condition of the loosing of the additional card installed in the card slot when computer is carried and bound to suffer shock, collision or falling to ground has been avoided. However, to install the additional card 20′ on the card slot 12′, it needs the two screw-and-nut modules 30′ and the two copper bars 23′, and using relative tools simultaneously, such as a screwdriver, moreover, when it is desired to exchange the additional card 11′, the screwdriver is a must to dismantle the screw-and-nut modules 30′ and the copper bars 23′, so as to cause inconvenience when exchanging the additional card 11′.

Accordingly, in view of the drawbacks and shortcomings of the fixing device of the prior art, the inventor of the present application has made great efforts to make inventive research thereon and eventually provided a bracket for fixing an additional card of a computer according to the present invention.

### SUMMARY OF THE INVENTION

The primary objective of the present invention is to provide a bracket for fixing an additional card of a computer capable of being installed on various additional card slots by human hands, so as to fasten the additional card.

Accordingly, to achieve the abovementioned objective, the inventor provides a bracket for fixing an additional card of a computer capable of being disposed on a card slot, so as to fix the additional card inserted into the card slot, the bracket comprises that of: a cover; a first fixing portion formed on one side of the cover and capable of retaining the additional card to avoid the additional card falling off; two second fixing portions being formed on one side adjacent to the side of the cover where the first fixing portion forming on, two ends of the second fixing portion having two third fixing portions respectively, through the second fixing portions and the third fixing portions, the bracket being able to be fastened on the card slot; an elastic portion being formed on another side of the cover where is opposite to the side for the first fixing portion forming on, the elastic portion and the first fixing portion being able to fix two sides of the additional card; and an auxiliary portion being disposed on the outer surface of the cover, the bracket being able to be attached to the card slot by utilizing the elasticity of the elastic portion when applying a force to the auxiliary portion, moreover, the bracket being able to be detached from the card slot easily when applying another force to the auxiliary portion.

### BRIEF DESCRIPTION OF THE SEVERAL VIEWS OF THE DRAWINGS

The invention as well as a preferred mode of use and advantages thereof will be best understood by referring to the following detailed description of an illustrative embodiment in conjunction with the accompanying drawings, wherein:

FIGS. 1A and 1B are schematic views of a fixing device for an additional card disposed on a card slot;

FIGS. 2A and 2B are stereo views of a bracket for fixing the additional card of a computer according to the present invention;

FIG. 3 is the schematic views of the bracket for fixing the additional card of the computer disposed on the card slot;

FIG. 4 is the stereo view of a DIMM slot disposed with the bracket;

FIG. 5 is the stereo view of a SO-DIMM slot disposed with the bracket;

FIG. 6 is the stereo view of a Mini-PCI slot disposed with the bracket;

FIG. 7 is the stereo view of an IDE cable connection device disposed with the bracket;

FIG. 8 is the stereo view of a cable connection device of a FAN power disposed with the bracket; and

FIG. 9 is the stereo view of the cable connection device of a motherboard power disposed with the bracket.

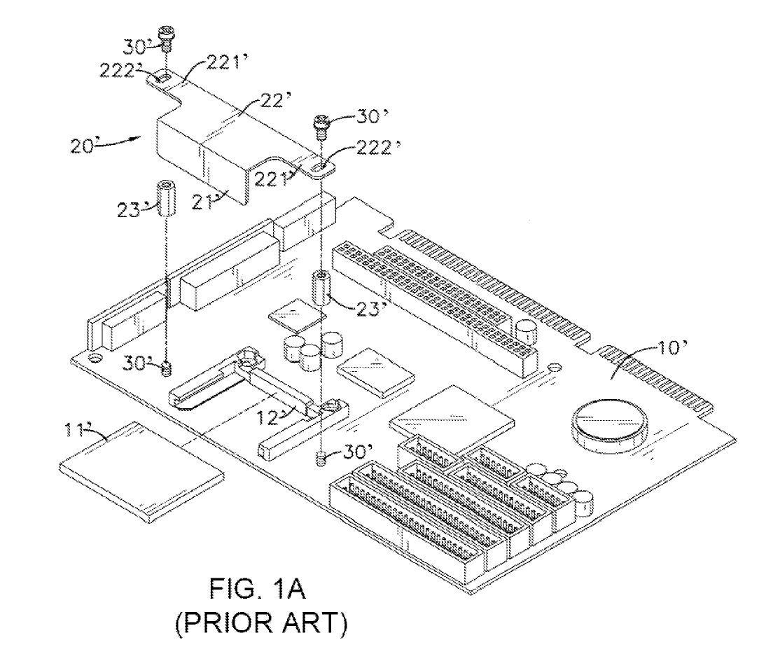

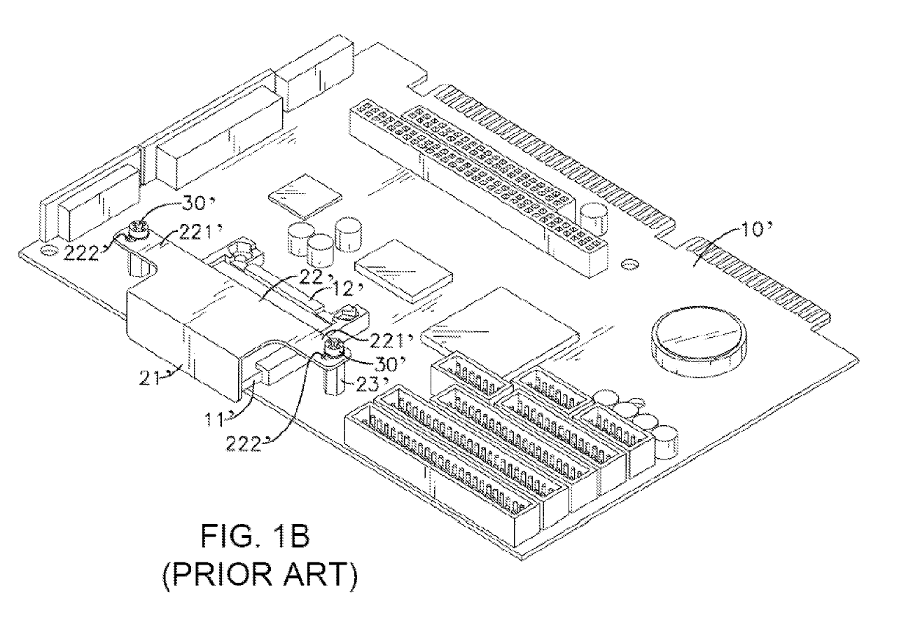

### DETAILED DESCRIPTION OF THE INVENTION

To more clearly describe a bracket for fixing an additional card of a computer according to the present invention, an embodiment of the present invention will be described in detail with reference to the attached drawings hereinafter.

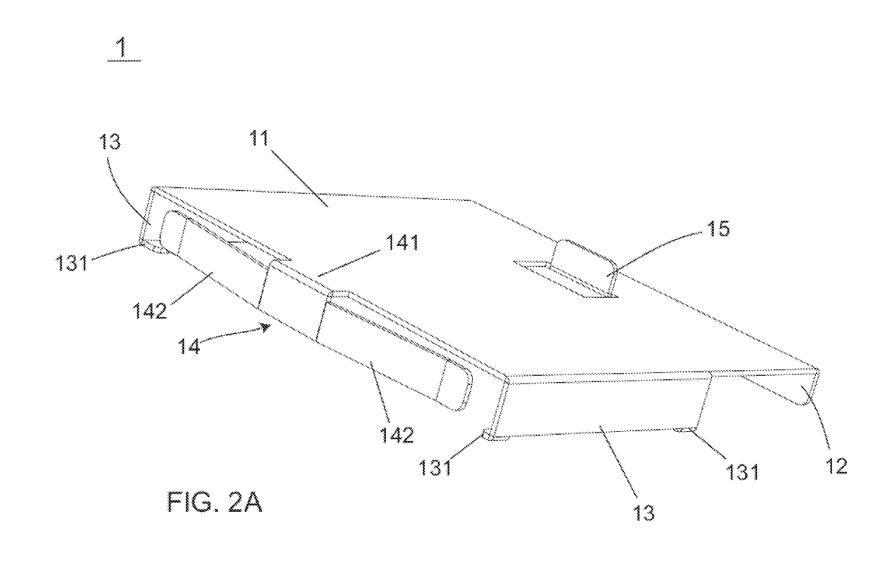

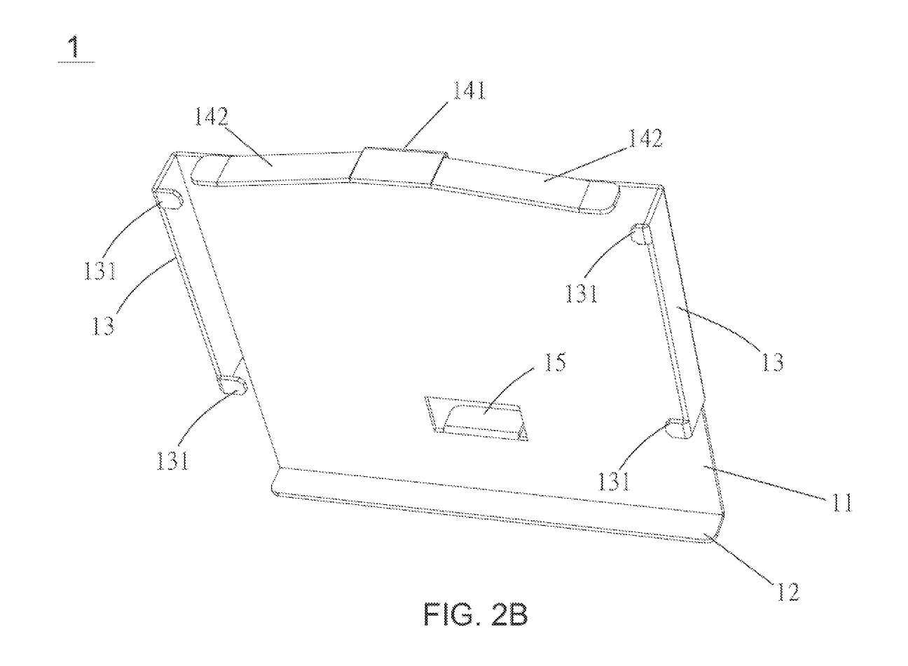

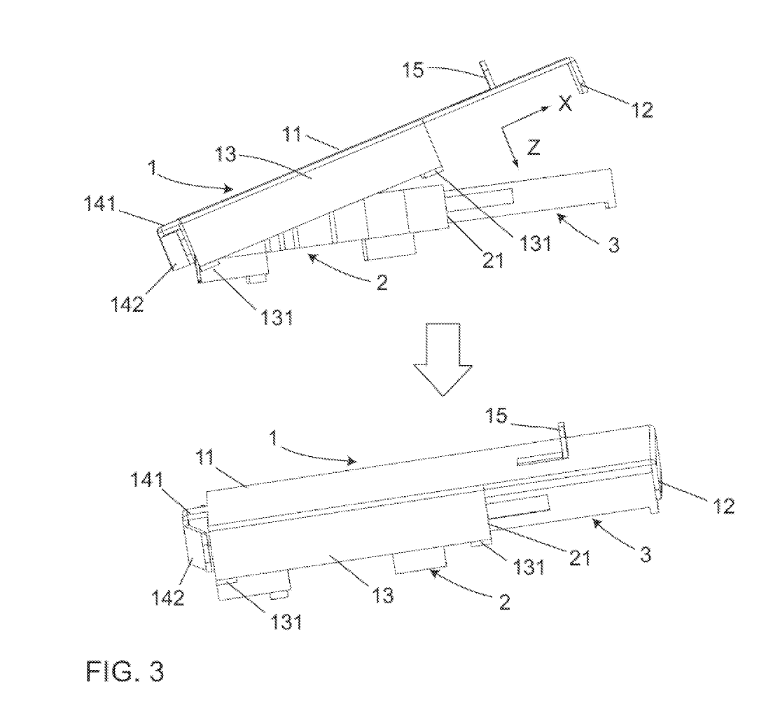

Referring to FIGS. 2A and 2B, which illustrate stereo views of the bracket for fixing the additional card of the computer according to the present invention, and simultaneously referring to FIG. 3, which illustrates a schematic views of the bracket for fixing the additional card of the computer disposed on a card slot, the bracket 1 for fixing the additional card of the computer being disposed on a card slot 2, so as to fasten the additional card 3 in the card slot 2 from an insertion end 21 thereof, the bracket 1 includes:

A cover 11 covered the additional card 3;

A first fixing portion 12, formed on one side of the cover 11 and capable of retaining the additional card 3 to avoid the additional card 3 falling off;

Two second fixing portions 13, formed on one side adjacent to the side of the cover 11 where the first fixing portion forming on, each of two ends of the second fixing portion 13 having a third fixing portions 131, wherein the bracket 1 can be installed on the card slot 2 and will not move up and down after the second fixing portions 13 are attached to the sides of the card slot 2 and the third fixing portions 131 are positioned at the lower edge of the card slot 2;

An elastic portion 14, formed on another side of the cover 11 where is opposite to the side for the first fixing portion forming on, the elastic portion 14 has a supporting portion 141 and two elastic members 142, supporting portion 141 extends out of the cover 11, the two elastic members 142 are formed on the supporting portion 141 oppositely, further that, the two sides of the additional card 3 can be fixed by the elastic portion 14 and the first fixing portion 12; and

An auxiliary portion 15, disposed on the outer surface of the cover 11, when applying a force to the auxiliary portion 15, the bracket 1 can be attached to the card slot 2 by utilizing the elasticity of the elastic portion 14 without using any other tool; moreover, when applying another force to the auxiliary portion 15, the bracket 1 is able to be easily detached from the card slot 2 by human hands.

When it is desired to installed the bracket 1 on the card slot 2, the bracket 1 is obliquely placed over the card slot 2 and the additional card 3 firstly, so as to facilitate the two elastic portions 142 close to one end opposite to the insertion end 21 of the card slot 2, then to make the second fixing portions 13 close to the sides of the card slot 2 and to position the third fixing portions 131 at the lower edge of the card slot 2, further that, the force is able to be applied to the auxiliary portion 15 and the elasticity of the two elastic portions 142 can be utilized, so as to facilitate the bracket 1 move a short distance along the X-direction, and then moving the bracket 1 toward the Z-direction and laying the bracket 1 on the card slot 2 and the additional card 3, so that the first fixing portion 12 is able to retain the additional card 3, and then the bracket 1 for fixing the additional card 3 of the computer is attached to the card slot 2.

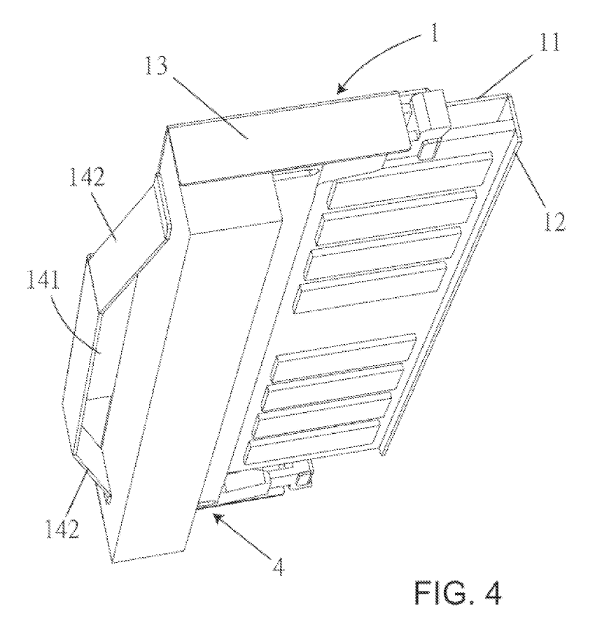

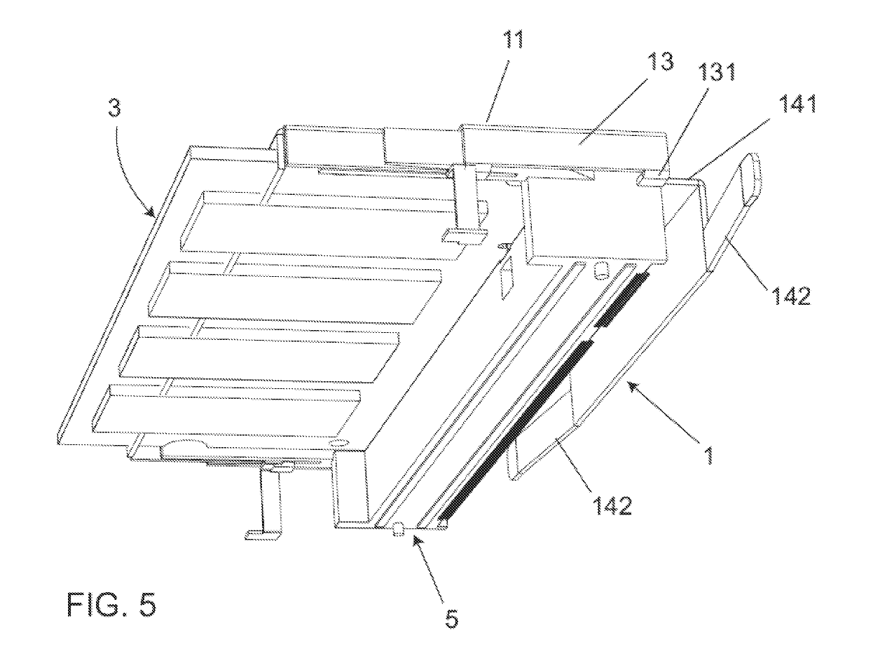

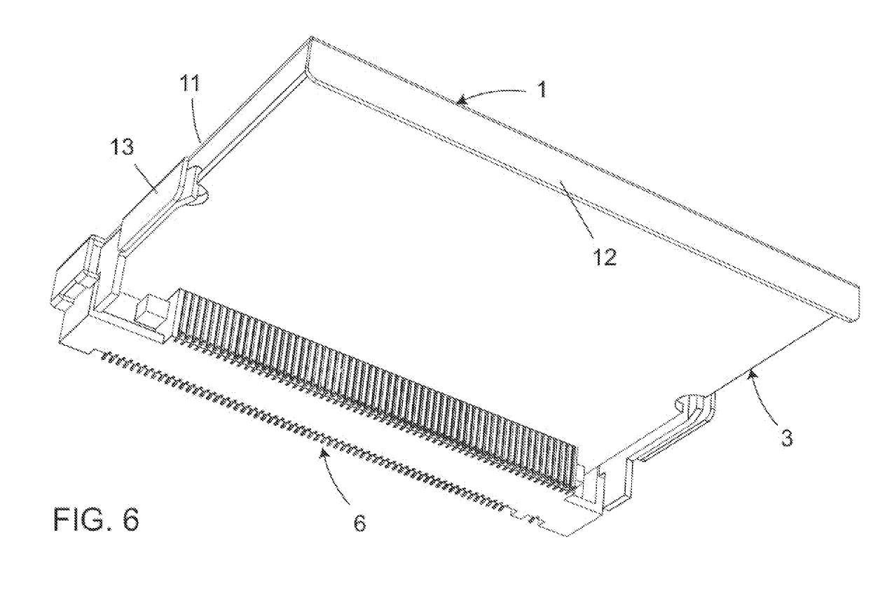

In the above mention, it is well know that the bracket 1 can be attached to the card slot 2 for avoiding the additional card 3 falling off, wherein by modulating the length and the width of the cover 11, the bracket 1 according to the present invention is adapted to install on various card slots 2, for example: a Dual In-line Memory Module (DIMM) slot, a Small Outline Dual In-line Memory Module (SO-DIMM) slot, a Peripheral Component Interface (PCI) slot, a Mini-PCI slot, and a Compact Flash (CF) slot. Referring to FIGS. 4, 5, and 6 together, which illustrate the stereo views of the DIMM slot, the SO-DIMM slot and the Mini-PCI slot disposed with the bracket. As shown in FIGS. 4, 5 and 6, to install the brackets 1 on the DIMM slot 4, the SO-DIMM slot 5 and the Mini-PCI slot 6 respectively capable of helping to fasten the additional cards inserted in the DIMM slot 4, the SO-DIMM slot 5 and the Mini-PCI slot 6.

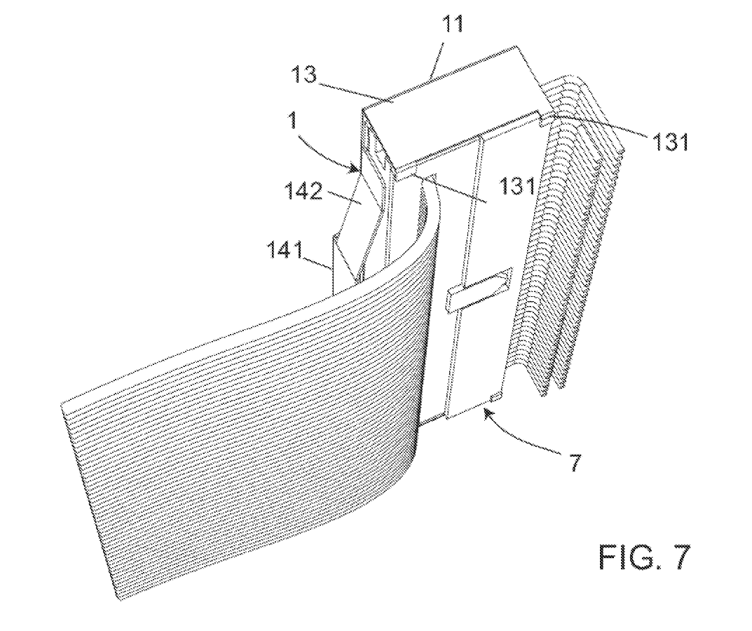

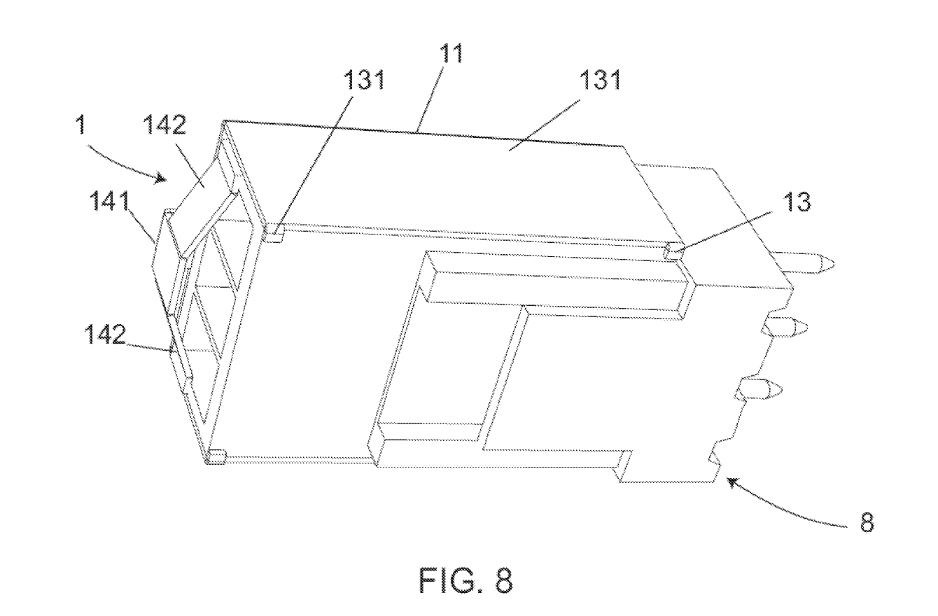

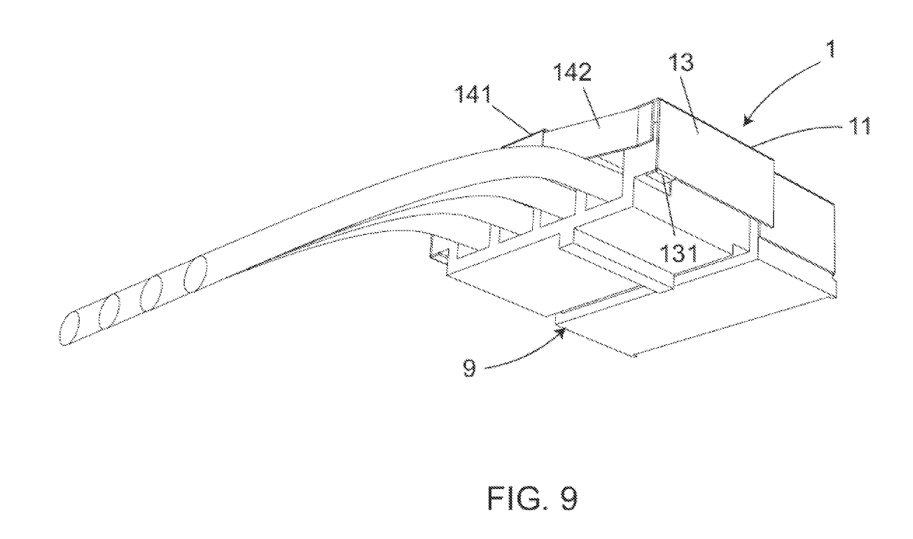

Moreover, please referring to FIGS. 7, 8 and 9 together, which illustrate the stereo views of an IDE cable connection device, a cable connection device of a FAN power and the cable connection device of a motherboard power disposed with the bracket. The above-mentioned bracket 1 is not only used for assisting to fix various additional cards 3 but also can be extensively adapted to fix a variety of cable connection devices of the computer, so as to fasten the cable connection devices. wherein by modulating the length and the width of the cover 11 and the extension length of the supporting portion 141, the bracket 1 according to the present invention is adapted to install on the variety of cable connection devices, for example: an IDE cable connection device 7, a cable connection device of a FAN power 8 and the cable connection device of a motherboard power 9. As shown in FIGS. 7, 8 and 9, the brackets 1 are installed on the IDE cable connection device 7, the cable connection device of the FAN power 8 and the cable connection device of the motherboard power 9 for avoid the cable connection devices falling off.

Thus, the bracket for fixing the additional card of the computer according to the present invention has been disclosed above completely and clearly. In summary, the present invention has the following advantages:

1. The bracket is able to be attached to and detached from the card slot easily through the auxiliary portion without using any other tool.

2. The bracket is not only used to fix various additional cards but also can be extensively applied in the variety of cable connection devices of the computer, so as to fasten the cable connection devices.

The above description is made on an embodiment of the present invention. However, this embodiment is not intended to limit scope of the present invention, and all equivalent implementations or alterations within the spirit of the present invention still fall within the scope of the present invention.

I claim:

1. A bracket for fixing an additional card of a computer being disposed on a card slot, so as to fix the additional card in the card slot, the bracket comprising:
a cover, being covered the additional card;
a first fixing portion, being formed on one side of the cover and capable of retaining the additional card to avoid the additional card falling off;
at least a second fixing portion, being formed on one side adjacent to the side of the cover where the first fixing portion forming on, each of two ends of the second fixing portion having a third fixing portions, wherein the bracket can be disposed on the card slot after the second fixing portion is attached to the side of the card slot and the third fixing portions are positioned at the lower edge of the card slot;
an elastic portion, being formed on another side of the cover where is opposite to the side for the first fixing portion forming on, the bracket being able to be fastened on the card slot through the elastic portion and the first fixing portion; and
an auxiliary portion, being disposed on the outer surface of the cover, the bracket being able to be attached to the card slot by utilizing the elasticity of the elastic portion when applying a force to the auxiliary portion, moreover, the bracket being able to be detached from the card slot easily when applying another force to the auxiliary portion.

2. The bracket for fixing the additional card of the computer of claim 1, wherein the elastic portion comprises a supporting portion and two elastic members, the bracket being attached to and detached from the card slot by utilizing the elasticity of the two elastic members when applying forces to the auxiliary portion.

3. The bracket for fixing the additional card of the computer of claim 1, wherein the card slot is selected from the group consisting of: a Dual In-line Memory Module (DIMM) slot, a Small Outline Dual In-line Memory Module (SO-DIMM) slot, a Peripheral Component Interface (PCI) slot, a Mini-PCI slot, and a Compact Flash (CF) slot.

4. The bracket for fixing the additional card of the computer of claim 1, wherein the bracket can further fix a cable connection device of the computer selected from the group consisting of: an IDE cable connection device, a cable connection device of a FAN power and the cable connection device of a motherboard power.
